(19) United States
(12) Patent Application Publication
(10) Pub. No.: US 2014/0351025 A1
(43) Pub. Date: Nov. 27, 2014

(54) EXTRAPOLATING USER ACTIONS

(71) Applicant: International Business Machines Corporation, Armonk, NY (US)

(72) Inventors: Judith H. Bank, Cary, NC (US); Liam Harpur, Dublin (IE); Ruthie D. Lyle, Durham, NC (US); Patrick J. O'Sullivan, Dublin (IE); Lin Sun, Morrisville, NC (US)

(73) Assignee: International Business Machines Corporation, Armonk, NY (US)

(21) Appl. No.: 13/901,699

(22) Filed: May 24, 2013

Related U.S. Application Data
(63) Continuation of application No. 13/899,686, filed on May 22, 2013.

(51) Int. Cl. G06Q 10/06

(52) U.S. Cl. CPC G06Q 10/06398
USPC 705/7.42

(57) ABSTRACT

There are provided a system, a method and a computer program product for extrapolating a next action for a user. The system enables the user to select or specify one or more role models. The system monitors data associated with the one or more role models. The system monitors data associated with the user. The system compares the data associated with the one or more role models with the data associated with the user. The system identifies, based on the comparison one or more discrepancies between the data associated with the one or more role models and the data associated with the user. The system suggests, based on the data associated with the one or more role models and based on the identified one or more discrepancies, one or more actions to the user.

### CROSS REFERENCE TO RELATED APPLICATION

This application is a continuation of U.S. patent application Ser. No. 13/899,686, filed May 22, 2013, the entire content and disclosure of which is incorporated herein by reference.

### BACKGROUND

This disclosure relates generally to selecting one or more role models, and particularly to suggesting actions to a user based on data associated with the selected role model.

### BACKGROUND OF THE INVENTION

Success in endeavors may be achieved by learning from and following actions of another person who has been proven to be successful. Such a person may be referred to as a role model. For example, a novice user may not be used to working in his or her environment, e.g., a business, a school, etc., but would like to achieve a success like a role model in a field of the novice user. For example, with increasing demands on business, it becomes important for a user to behave or to interact in a way that can lead to achieving a goal of the user.

### SUMMARY

A system, a method and a computer program product may be provided for extrapolating a next action for a user. The system may enable the user to select or specify one or more role models. The system may also monitor data associated with the one or more role models. The system may further monitor data associated with the user. The system may compare the data associated with the one or more role models with the data associated with the user. The system may identify, based on the comparison, one or more discrepancies between the data associated with the one or more role models and the data associated with the user. The system may suggest, based on the data associated with the one or more role models and based on the identified one or more discrepancies, one or more actions to the user.

While comparing the data associated with the one or more role models with the data associated with the user, the system may identify at least one similarity between the data associated with the one or more role models and the data associated with the user.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 illustrates a flowchart that describes a method for extrapolating user actions in one embodiment;

FIG. 2 illustrates examples of a computing system that can run the methods illustrated in FIGS. 1 and 3-4;

FIG. 3 illustrates a method for monitoring of data associated with role models in one embodiment; and

FIG. 4 illustrates a method for monitoring of data associated with a user in one embodiment.

### DETAILED DESCRIPTION

There is provided a system, a method, and a computer program product for extrapolating next actions for a user, e.g., in user's business or another relationship. Many individuals, teams, departments, and/or organizations may want to perform well, e.g., in achieving a goal. In achieving such goals, user interactions and actions should be managed properly. In one embodiment of the present disclosure, one or more next actions a user should perform may be suggested based on analyzing one or more actions of another user, e.g., a role model or the like.

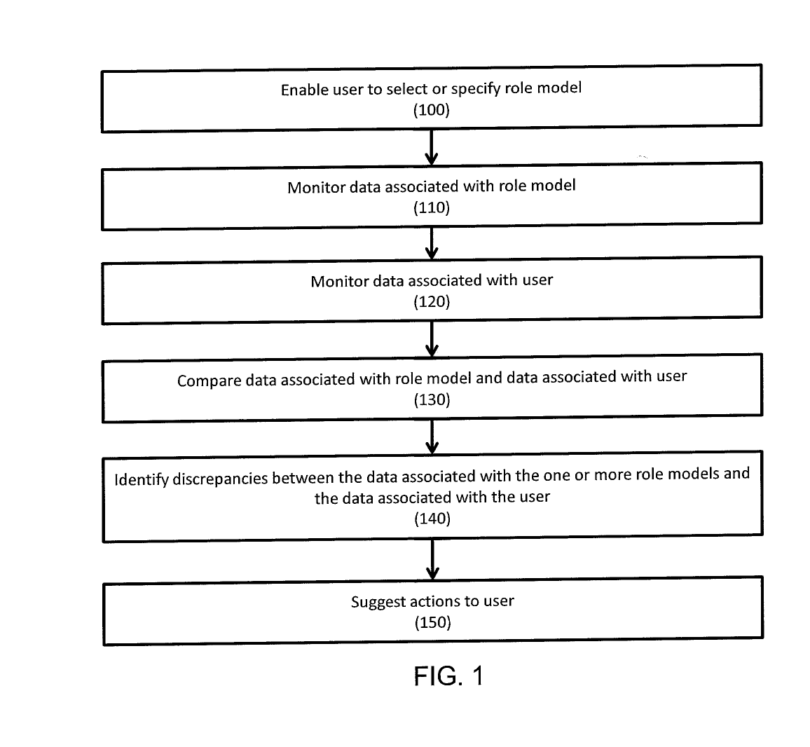

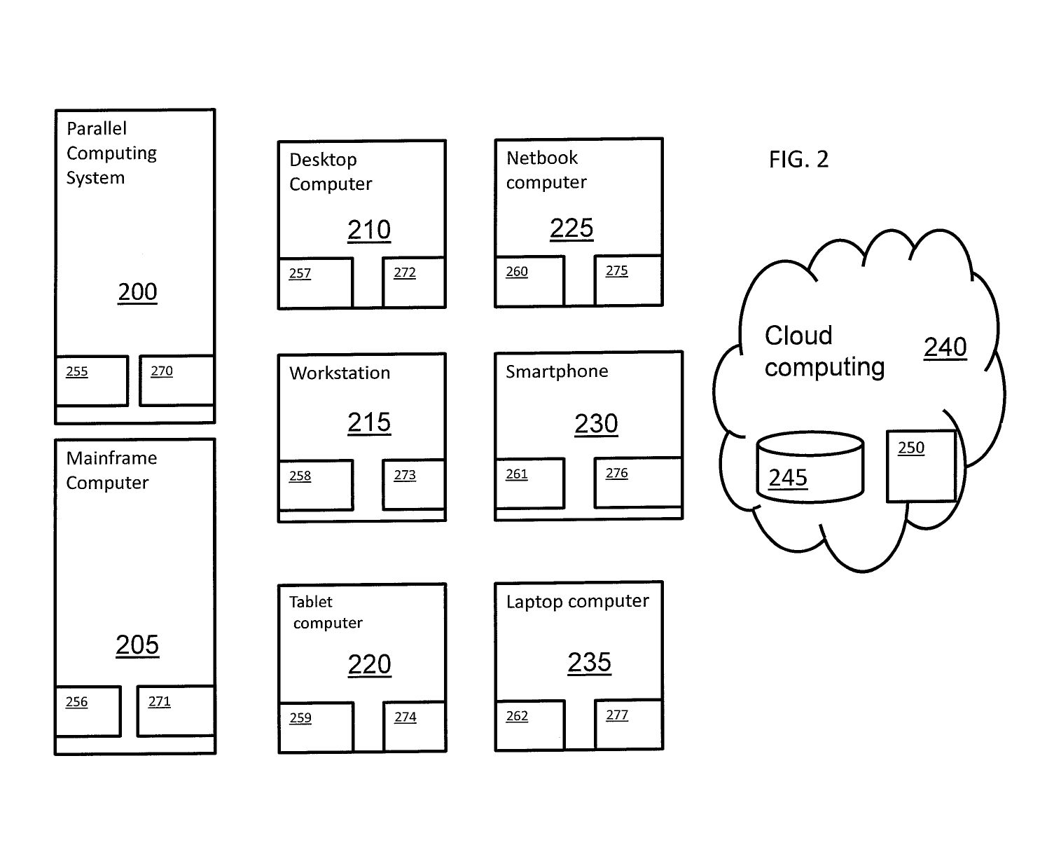

FIG. 1 illustrates a flowchart that describes a method for extrapolating a next action for a user. In one embodiment, a computing system may run the method illustrated in FIG. 1. FIG. 2 illustrates examples of the computing system. An example computing system may include, but are not limited to: a parallel computing system 200 including at least one processor 255 and at least one memory device 270, a mainframe computer 205 including at least one processor 256 and at least one memory device 271, a desktop computer 210 including at least one processor 257 and at least one memory device 272, a workstation 215 including at least one processor 258 and at least one memory device 273, a tablet computer 220 including at least one processor 256 and at least one memory device 274, a netbook computer 225 including at least one processor 260 and at least one memory device 275, a smartphone 230 including at least one processor 261 and at least one memory device 276, a laptop computer 235 including at least one processor 262 and at least one memory device 277, or a cloud computing system 240 including at least one storage device 245 and at least one server device 250.

Returning to FIG. 1, at 100, the computing system enables the user to select or specify one or more role models. In one embodiment, there is provided a database (not shown) that organizes categories of variety of goals. For example, a category of these goals may be “success in a sales business.” Another category of these goals may be “develop business relationships.” Under each category of these goals, the database may also store one or more role models who have achieved a corresponding goal. In this embodiment, in order to enable the user to select or specify one or more role models, the computing system enables the user to select a category that specifies a goal of the user. The computing system filters out role models who do not belong to the selected category. Once the user selects a category, the computing system may display profiles of role models under the selected category. The computing system may further enable the user to choose one or more role models under the selected category, e.g., based on user's knowledge.

At 110, the computer system monitors data associated with the chosen role model. In one embodiment, in order to monitor the data associated with the chosen role model, the computing system may utilize project management software, monitoring software and/or any other similar tools. The project management software is used to plan one or more projects of the chosen role model, identify scopes of the projects and estimate workforce needed for the projects. The monitoring software monitors one or more devices used by the chosen role model, for example, one or more computers of the chosen role model, one or more network devices associated with the chosen role model, and/or other devices which the role model may be used in performing his or her functions in the category.

The computing system collects in real-time, e.g., by monitoring email client software or the project management software of the chosen role model, etc., data associated with the chosen role model. The data associated with the chosen role model includes, but is not limited to: (1) identifier(s) of the chosen role model (the identifiers of the role model may be available by monitoring email communications of the role model); (2) categories of events that the chosen role model participated (e.g., a category of the events may be a business conference, another category of the events may be a business lunch, etc; data representing these events may be available by monitoring an electronic calendar that the role model uses); (3) categories of interactions that the chosen role model had (e.g., a category of the interactions may be meeting with an executive of a client company, another category of the interactions may be email communications with a manager of role model's company, etc.; data representing these interactions may be available by monitoring an email client software that the role model uses); (4) categories of projects that the chosen role model participated (e.g., a category of the projects may be building an elementary school, another category of the projects may be constructing a bridge, etc.; data representing these projects may be available by monitoring the project management software that the role model uses); (5) time durations of the projects that the chosen role model participated (data representing these time durations may be available by monitoring the project management software that the role model uses); or (6) categories of actions that the chosen role model has taken (e.g., a category of the actions may be a software application development, another category of the actions may be performing a sales role, etc.; data representing these actions may be available by monitoring the project management software and/or email client software that the role model uses.) In one aspect, the monitoring and collecting of the data associated with the role model are performed with the understanding that the role model has been notified and has given permission for such monitoring and collecting, e.g., consented to being a role model whose data would be monitored and collected.

In one embodiment of the present disclosure, to collect the data associated with the chosen role model, the computing system may continuously monitor the actions of the chosen models, e.g., by continuously monitoring the project management software of the chosen role model. The computing system may also continuously monitors the interactions of the one or more role models, e.g., by continuously monitoring the email client software of the chosen role model. The computing system may also continuously monitor progresses of the projects, e.g., by continuously monitoring the project management software of the chosen role model. The computing system may also continuously monitor progresses of the events, e.g., by continuously monitoring the electronic calendar of the chosen role model.

In one embodiment, the computing system stores, e.g., in a storage device, the collected data associated with the chosen role model. The storage device may also store historical data associated with the chosen role model. This historical data may include, but is not limited to: previously collected data associated with the chosen role model based on one or more of: (1) prior events that the chosen role model attended; (2) prior interactions that the chosen role model had; (3) prior projects that the chosen role model participated; (4) time durations of the prior projects; and/or (5) prior actions that the chosen role model has taken. In one embodiment, the collected and stored data associated with the chosen role model includes one or more free-form texts, i.e., natural language texts, associated with the chosen role model.

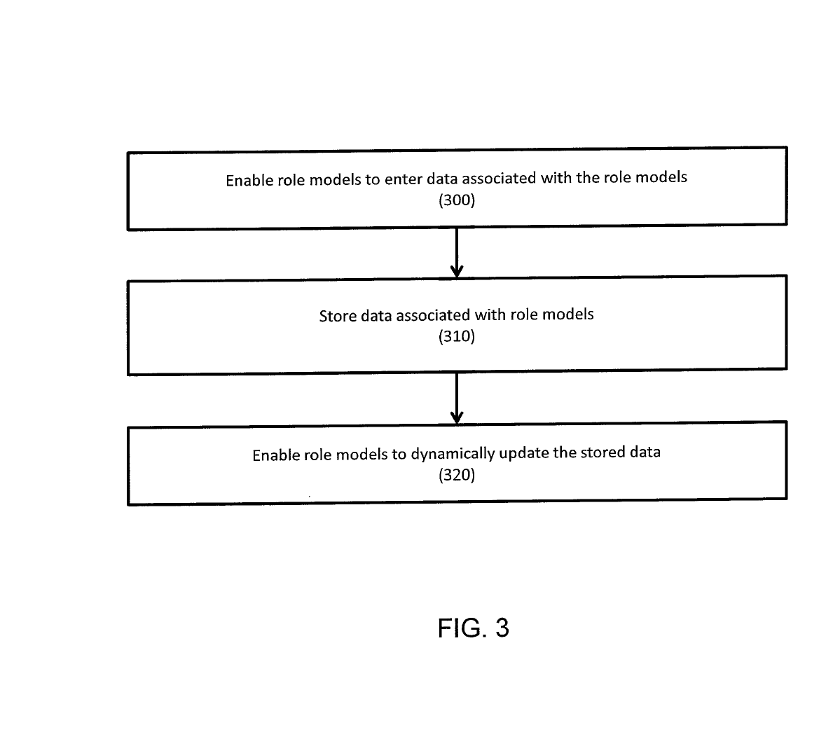

FIG. 3 illustrates a flowchart that describes a method for monitoring the data associated with the chosen role model in one embodiment. At 300, the computing system enables the chosen role model to enter the data associated with the chosen role model. At 310, the computing system stores, e.g., in a storage device, the entered data associated with the chosen role model. At 320, the computing system enables the chosen role model to dynamically update the stored data associated with the chosen role model, e.g., by enabling the chosen role model to update an electronic profile of the chosen role model whenever the chosen role model wants to update.

Returning to FIG. 1., at 120, the computing system monitors data associated with the user. The computing system collects in real-time, e.g., by monitoring email client software or project management software of the user, etc. data associated with the user. The data associated with the user includes, but is not limited to: (1) an identifier of the user; (2) a category of a project that the user participates (e.g., a category of the project may be building an elementary school, etc.); (3) categories of interactions that the user has had (e.g., a category of the interactions may be meeting with an executive in a client company, etc.); (4) categories of actions that the user has taken (e.g., a category of the actions may be bidding to a project, etc.); (5) a time duration of the project that the user participates; or (6) a phase of the project that the user participates.

In order to collect the data associated with the user, the computing system continuously monitors a progress of the project that the user participates, e.g., by continuously monitoring the project management software of the user. The computing system may also continuously monitor the interactions of the user, e.g., by continuously monitoring the email client software of the user. The computer system may also continuously monitors the actions of the user, e.g., by continuously monitoring the project management software and/or the email client software of the user.

In one embodiment, the computing system stores, e.g., in a storage device, the collected data associated with the user. The storage device may also store historical data associated with the user. This historical data may include, but is not limited to: previously collected data associated with the user based on one or more of: (1) prior events that the user attended; (2) prior interactions that the user had; (3) prior projects that the user participated; (4) time duration of the prior projects that the user participated; and/or (5) prior actions that the user took. In one embodiment, the collected and stored data associated with the user includes one or more free-form texts, i.e., natural language texts, associated with the user.

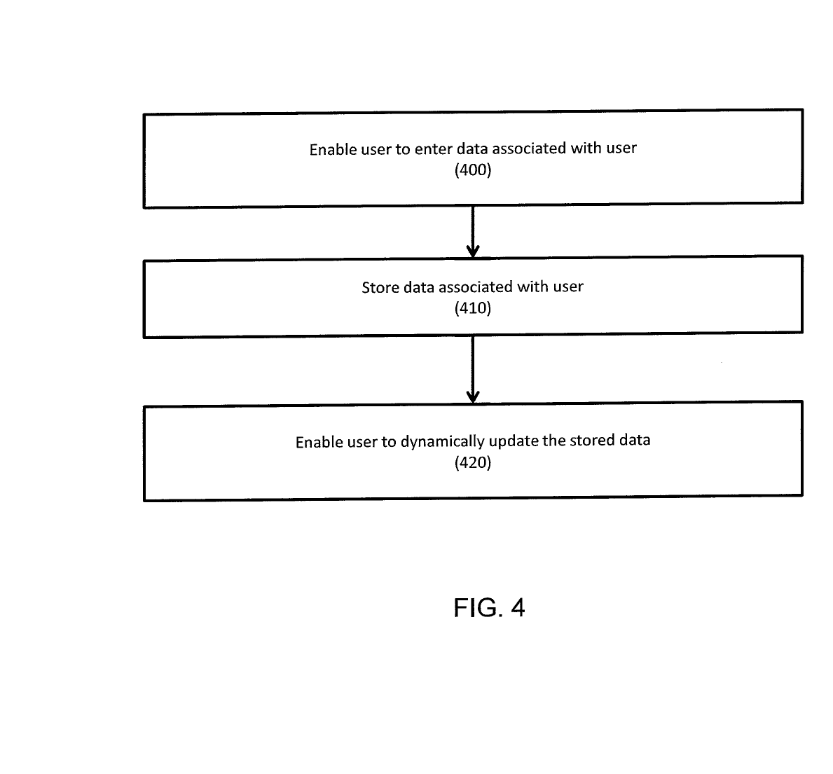

FIG. 4 illustrates a flowchart that describes a method for monitoring the data associated with the user in one embodiment. At 400, the computing system enables the user to enter the data associated with the user. At 410, the computing system stores, in a storage device, the data associated with the user. At 420, the computing system enables the user to dynamically update the stored data associated with the user, e.g., by enabling the user to update a project status that the user participates whenever the user wants.

Returning to FIG. 1, at 130, the computing system compares the data associated with the chosen role model with the data associated with the user. The computing system may perform the comparison based on one or more criteria, for example, based on one or more of: (1) a time duration of a project of the user, and time durations of the projects of the chosen role model; (2) categories of actions that the user has taken, and the categories of the actions that the chosen role model has taken; (3) one or more users that the user plans to work together for a project, and one or more users that the chosen role model worked together for projects; (4) categories of events that the user has participated, and the categories of the events that the chosen role model has participated; and/or (5) categories of interactions that the user has had, and the categories of the interactions that the chosen role model has had.

Returning to FIG. 1, at 140, while performing the comparison, the computing system identifies at least one similarity between the data associated with the chosen role model and the data associated with the user. The computing system identifies at least one discrepancy between the data associated with the chosen role model and the data associated with the user. For example, assume that the data associated with the chosen role model includes a first free-form text: “user A joined XYZ Ltd. in 2001.” Further assume that the data associated with the user includes a second free-form text: “user B joined XYZ Ltd. in 2012.” By running a free-form text comparison tool that finds the difference between these two free-form texts, the computing system can identify a similarity between the two free-form texts: user A and user B joined XYZ Ltd. The computing system can also identify a discrepancy between the two free-form texts: “2001” and “2012.”

At 150, the computing system suggests, based on the data associated with the chosen role model and based on the identified discrepancy, one or more actions to the user. The suggested actions may depend on the point in time of the suggestions. For example, if the computing system detects that the user is currently involved in a project, e.g., by monitoring the project management software of the user, the computing system may recommend to the user only a subset of the one or more suggested actions, which are associated with the involved project. For example, the subset of the suggested actions may suggest to replace one or more users in the involved project with other users with whom the chosen role model worked together for projects which belongs to a same category of the involved project.

Based on the identified discrepancy, the computing system suggests one or more actions to the user. For example, consider the following scenario. Assume that the data associated with the chosen role model indicates that the chosen role model performed a sales and operation manager role for five years and performed a sales and operation vice president role for next five years. Further assume that the data associated with the user indicates that the user has performed a sales and operation manager role for five years. By comparing the data associated with the chosen role model and the data associated with the user, the computing system may identify a similarity that both the user and the chosen role model spent five years as a manager. The computing system may also identify a discrepancy that the chosen role model also spent five years as the sales and operation vice president but the user has not worked in that capacity. Based on this discrepancy, the computing system suggests to the user one or more actions of the chosen role model that the chosen role model has performed as the vice president.

Examples of the suggested action may comprise one or more of: (1) substituting one or more users in the user's project with other users; (2) substituting the user's project with another project; (3) recommending changes in the actions of the user based on actions of the chosen role model; (4) creating a list of one or more users that the user is recommended to meet; (5) creating a list of one or more projects that the user is recommend to work on and providing associated timelines of those one or more projects; (6) recommending to the user a work efficiency the user achieves; and/or (7) recommending to the user one or more changes. In one embodiment, the computing system sends the one or more suggested actions to the user, e.g., via an email, an electronic text, and/or another communications mode. By adopting the one or more suggested actions, the user can progress his or her project by following a tried or trusted path of the role model.

The computing system sends an electronic alert to the user if the computing system identifies the discrepancy between the data associated with the chosen role model and the data associated with the user. The sent alert may include the suggested one or more actions. The computing system may also create a flowchart of the suggested one or more actions. The flowchart may arrange the one or more suggested actions according to an order that the role model has taken. The computing system estimates, based on the data associated with the chosen role model, an efficiency of an action or interaction of the user: for example, if the user has taken an action, the computing system estimates whether the taken action conforms to the data associated with the chosen role model, e.g., by evaluating a category of the taken action and further evaluating whether the chosen role model has taken an action in the same category.

Based on the one or more suggested actions, the user can plan future schedules or events by knowing that the user is leveraging the tried or trusted path of the chosen role model. In one embodiment, while providing the one or more suggested actions, the computing system may also provide contact information of the chosen role model to the user. If the user establishes a relationship with the chosen role model, e.g., by contacting the role model frequently, the relationship between the user and the chosen role model may improve throughout a lifetime of the relationship. In one embodiment, the computing system runs 130-150 in FIG. 1 whenever the computing system collects new data associated with the chosen role model or new data associated with the user.

The following describes a usage scenario. User A wants to develop a sales business. A database (not shown) stores an electronic profile of User B as follows: “User B worked as a software engineer developing C++ applications until three years ago,” “User B then spent two years in a sales role and interacted with CEOs of two other software companies,” “User B attended a business entrepreneur forum.” The computing system enables User A to select a category associated with the goal of User A. For example, the computing system may present one or more categories of goals of users: category 1—“replicate business success”; category 2—“develop business relationships”; category 3—“achieve a work rate,” etc. User A selects category 1. Then, User A selects User B who is presented as one of role model under the category 1.

Upon the selection of User B, the computing system retrieves data associated with User B, e.g., the electronic profile of User B, from the database. The computing system also collects data associated with User A. The computing system compares the data associated with User B and the data associated with User A based on one or more following factors: (1) a time duration of a project of User A, and time durations of the projects of User B; (2) categories of actions that User A has taken, and the categories of the actions that the User B has taken; (3) one or more users with whom User A plans to work together for a project, and one or more users with whom the User B worked together for projects; (4) categories of events that User A has participated, and the categories of the events that the User B has participated; and/or (5) categories of interactions that User A has had, and the categories of the interactions that User B has had. Based on the comparison, the computing system identifies the similarity and the discrepancy between the User B's data and the User A's data.

The computing system may also enable User A to assign a different weight or priority to each comparison factor. For example, if the user assigns a highest weight or priority to the time duration of the user's project, the computing system may compare only between time duration of a project of User A and time durations of the projects of User B.

The computing system removes noise in the identified discrepancy between the User B's data and the User A's data. For example, User A's data may include a free-form text associated with User A: “User A joined XYZ Ltd. in 2012.” Then, the computing system runs a content analysis tool or a text mining tool or a similar tool on the User B's data to identify a pattern, “<company name> Ltd. or Inc. in <year>” in User B's data. If the User B's data includes a first free-form text associated with User B “User B joined OPQ Ltd. in 2001” and a second free-form text associated with User B “User B sold his house to User B's nephew.” Then, by running the content analysis tool or the text mining tool or the similar tool on the User B's data, the computing system determines the second free-form text is noise because the second free-form text does not conform to the pattern. However, the computing system determines the first free-form text conforms to the pattern. The computing system identifies the discrepancy between the User B's data and the User A's data as follows: “OPQ Ltd.” and “2001.”

Based on the identified discrepancy without the noise, the computing system suggests one or more actions to User A. For example, assume that after joining OPQ Ltd. in 2001, User B has been promoted every year and now becomes a vice president of OPQ Ltd. The User B's data may include data representing one or more of: categories of business interactions that User B has taken since 2001, categories of events that User B has participated since 2001, users that User B has met since 2001. Then, the computing system suggests one or more actions to User A, for example, “take one or more actions in those same categories that the User B's business interactions belong to,” “participate one or more events in those same categories that the User B's events belong to,” “meet one or more available users among the users that User B has met,” via an email, an electronic text, etc. Furthermore, the computing system may create a flowchart that arranges the one or more suggested actions according to an order that User B has taken. The computing system provides the created flowchart to User A in order to assist User A to follow the one or more suggested actions in the order that User B has taken. In one embodiment, the one or more suggested actions are more generic or abstract, for example, identifying categories of events to participate rather than specifically naming particular events to participate.

In one embodiment, the methods shown in FIGS. 1 and 3-4 may be implemented as hardware on a reconfigurable hardware, e.g., FPGA (Field Programmable Gate Array) or CPLD (Complex Programmable Logic Device), by using a hardware description language (Verilog, VHDL, Handel-C, or System C). In another embodiment, the methods shown in FIGS. 1 and 3-4 may be implemented on a semiconductor chip, e.g., ASIC (Application-Specific Integrated Circuit), by using a semi custom design methodology, i.e., designing a semiconductor chip using standard cells and a hardware description language.

In one embodiment, there is provided a method for extrapolating an action for a user. The method comprises: enabling the user to select or specify one or more role models; monitoring data associated with the one or more role models; monitoring data associated with the user; comparing the data associated with the one or more role models with the data associated with the user; identifying, based on the comparing, one or more discrepancies between the data associated with the one or more role models and the data associated with the user; and suggesting, based on the data associated with the one or more role models and based on the identified one or more discrepancies, one or more actions to the user, wherein a processor coupled to a memory device is configured to perform: the enabling, the monitoring the data associated with the one or more role models, the monitoring the data associated with the user, the comparing, the identifying and the suggesting.

In a further embodiment, the monitoring the data associated with the one or more role models comprises: continuously monitoring the actions of the one or more role models; continuously monitoring the interactions of the one or more role models; continuously monitoring progresses of the projects; continuously monitoring progresses of the events; or combinations thereof.

In a further embodiment, the monitoring the data associated with the user further comprises: continuously monitoring a progress of the project; continuously monitoring the interactions of the user; and continuously monitoring the actions of the user.

In a further embodiment, the monitoring the data associated with the one or more role models comprises: enabling the one or more role models to enter the data associated with the one or more role models; storing, in a storage device, the data associated with the one or more role models; and enabling the one or more role models to dynamically update the stored data associated with the one or more role models.

In a further embodiment, the monitoring the data associated with the user comprises: enabling the user to enter the data associated with the user; storing, in a storage device, the data associated with the user; and enabling the user to dynamically update the stored data associated with the user.

In a further embodiment, the comparing comprises: identifying at least one similarity between the data associated with the one or more role models and the data associated with the user.

In a further embodiment, the method further comprises: sending an alert to the user if the one or more discrepancies are identified, the alert including the suggested one or more actions.

In a further embodiment, the method further comprises: creating a flow chart of the suggested one or more actions.

In a further embodiment, the method further comprises: estimating, based on the data associated with the one or more role models, an efficiency of an action or interaction of the user.

In a further embodiment, the method further comprises: removing one or more noises among the identified discrepancies that do not conform to a pattern of the data associated with the user.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for extrapolating a next action for a user, the method comprising:
enabling the user to select or specify one or more role models;
monitoring data associated with the one or more role models;
monitoring data associated with the user;
comparing the data associated with the one or more role models with the data associated with the user;
identifying, based on the comparing, one or more discrepancies between the data associated with the one or more role models and the data associated with the user; and
suggesting, based on the data associated with the one or more role models and based on the identified one or more discrepancies, one or more actions to the user,
wherein a processor coupled to a memory device is configured to perform: the enabling, the monitoring the data associated with the one or more role models, the monitoring the data associated with the user, the comparing, the identifying and the suggesting.

2. The method according to claim 1, wherein the data associated with the one or more role models include one or more free-form texts associated with the one or more role models.

3. The method according to claim 1, wherein the data associated with the user include one or more free-form texts associated with the user.

4. The method according to claim 1, wherein the data associated with the one or more role models comprises one or more of:
names of the one or more role models;
categories of events that the one or more role models participated;
categories of interactions that the one or more role models had;
categories of projects that the one or more role models participated;
time durations of the projects that the one or more role models participated; or
categories of actions that the one or more role models have taken; or
combinations thereof.

5. The method according to claim 4, wherein the monitoring the data associated with the one or more role models comprises:
continuously monitoring the actions of the one or more role models;
continuously monitoring the interactions of the one or more role models;
continuously monitoring progresses of the projects;
continuously monitoring progresses of the events; or
combinations thereof.

6. The method according to claim 4, wherein the comparing is based on one or more of:
a time duration of a project of the user;
time durations of the projects of the one or more role models;
categories of actions that the user has taken;
the categories of the actions that the one or more role models have taken;
one or more users that the user plans to work together for a project;
one or more users that the one or more role models worked together for projects;
categories of events that the user has participated;
the categories of the events that the one or more role models have participated;
categories of interactions that the user has had; or
the categories of the interactions that the one or more role models has had; or
combinations thereof.

7. The method according to claim 1, wherein the data associated with the user comprises one or more of:
a name of the user;
a category of a project that the user participates;
categories of interactions that the user has had;
categories of actions that the user has taken;
a time duration of the project; or
a phase of the project; or
combinations thereof.

8. The method according to claim 7, wherein the suggested action comprises one or more of:
substituting one or more users in the project with other users;
substituting the project with another project in the same category;
recommending changes in the actions of the user based on actions of the one or more role models;
creating a list of one or more users that the user is recommended to meet;
creating a list of one or more projects that the user is recommend to work on;
recommending to the user a work efficiency the user achieves; or
recommending to the user one or more changes; or
combinations thereof.

9. The method according to claim 7, wherein the monitoring the data associated with the user further comprises:
continuously monitoring a progress of the project;
continuously monitoring the interactions of the user; and
continuously monitoring the actions of the user.

10. The method according to claim 1, wherein the monitoring the data associated with the one or more role models comprises:
enabling the one or more role models to enter the data associated with the one or more role models;
storing, in a storage device, the data associated with the one or more role models; and
enabling the one or more role models to dynamically update the stored data associated with the one or more role models.

11. The method according to claim 1, wherein the monitoring the data associated with the user further comprises:
enabling the user to enter the data associated with the user;
storing, in a storage device, the data associated with the user; and
enabling the user to dynamically update the stored data associated with the user.

12. The method according to claim 1, wherein the comparing comprises:
identifying at least one similarity between the data associated with the one or more role models and the data associated with the user.

13. The method according to claim 1, further comprising:
sending an alert to the user if the one or more discrepancies are identified, the alert including the suggested one or more actions.

14. The method according to claim 1, further comprising:
creating a flow chart of the suggested one or more actions.

15. The method according to claim 1, further comprising:
estimating, based on the data associated with the one or more role models, an efficiency of an action or interaction of the user.

16. The method according to claim 1, further comprising:
removing one or more noises among the identified discrepancies that do not conform to a pattern of the data associated with the user.
